(19) United States
(12) Patent Application Publication
(10) Pub. No.: US 2011/0225425 A1
(43) Pub. Date: Sep. 15, 2011

(54) PREVENTING CAUSALITY VIOLATIONS IN DECENTRALIZED DISTRIBUTED SYSTEMS

(75) Inventors: Ramakrishna R. Kotla, Sunnyvale, CA (US); Indrajit Roy, Austin, TX (US)

(73) Assignee: Microsoft Corporation, Redmond, WA (US)

(21) Appl. No.: 12/721,576

(22) Filed: Mar. 11, 2010

(51) Int. Cl. H04L 9/32

(52) U.S. Cl. 713/175; 713/181

(57) ABSTRACT

A trusted read and write platform provides write-indisputability and read-undeniability for a distributed application. The platform is implemented at each node of the distributed application using a trusted platform module. To provide write-indisputability, the read and write platform of a node may generate a proof that is signed by the platform module and sent with a purportedly written result. The proof is decrypted using a public key associated with the platform module and includes indicators of the process taken by the read and write platform to write the result. To provide read-undeniability, the read and write platform may bind a key to a state of the platform module. A result to be read at the read and write platform is encrypted using the key and can only be decrypted when the read and write platform updates its state to the bound state.

### BACKGROUND

The use of decentralized distributed systems is growing. These systems typically comprise weakly connected nodes and are mostly decentralized. Examples of decentralized distributed systems include online games, cooperative data sharing systems such as peer-to-peer file sharing systems (e.g., BitTorrent), and weakly consistent replication systems. While the decentralized nature of such systems and weakly connected nodes provide many advantages in distributed networking environments such as the Internet, there are also problems associated with such systems. For example, one longstanding problem in decentralized distributed systems is that of preventing causality violations by securing the causal relationships of events in the presence of adversarial nodes. An adversarial node may change the observed order of events by the correct nodes from the real order in which the events actually occurred to the adversarial node.

Such causality violations manifest as two broad classes of attacks: (1) read-denial attacks; and (2) write-equivocation attacks. A read-denial attack is an attack where the adversarial node can deny having processed a read event of an incoming message, or may change the order in which it read events of incoming messages with respect to other events that occurred at the adversarial node. For example, with respect to an online game, an adversarial node may receive a message with an event indicating a move made by an opponent. The adversarial node may then pretend that it had already performed an event corresponding to a counter to the move before the message was received.

A write-equivocation attack may is an attack where the adversarial node lies about the contents of a write event, or the order that it wrote certain events. For example, in a peer-to-peer system with file upload quotas, the adversarial node may lie to other nodes about the amount of data that has been uploaded by the adversarial node. The adversarial node may then receive the benefits and privileges associated with data upload without having in fact uploaded the requisite amount of data.

### SUMMARY

A trusted read and write platform is provided to provide write-indisputability and read-undeniability for a distributed application. The read and write platform is implemented at each node of the distributed application using a trusted platform module. To provide write-indisputability, the trusted read and write platform of a node may generate a proof that is signed by the trusted platform module and sent with a purportedly written result. The proof can be decrypted using a public key associated with the trusted platform module and includes indicators of the process taken by the trusted platform to write the result. To provide read-undeniability, the trusted read and write platform may bind a key to a particular state of the trusted platform module. A result that is to be read at the trusted read and write platform is encrypted using the key and can only be decrypted by another node when the trusted read and write platform of the other node updates its state to the particular bound state.

In an implementation, a result is generated by a first computing device. The first computing device may include a cryptographically secure component, and the cryptographically secure component may include an associated certificate. A state digest associated with the cryptographically secure component is updated by the first computing device to reflect the generation of the result. A proof that the state digest was updated is generated by the cryptographically secure component of the first computing device. The result, the updated state digest, and the generated proof are sent to a second computing device through a network by the first computing device.

Implementations may include some or all of the following features. A count value may be associated with the cryptographically secure component. The count value may be updated and sent to the second computing device. A determination may be made that the first computing device generated the result using the result, the updated state digest, and the generated proof. The cryptographically secure component may be a trusted platform module. The certificate may be bound to the cryptographically secure component. Updating a state digest associated with the cryptographically secure component by the first computing device to reflect the generation of the result may include retrieving the state digest associated with the cryptographically secure component from a secure register of the cryptographically secure component, updating the state digest using the retrieved state digest and the result, and storing the updated state digest in the secure register of the cryptographically secure component. The secure register may be a platform configuration register. The state digest may be an SHA1 (secure hash algorithm 1) digest.

In an implementation, a result is generated at a first computing device. A request for a state digest is sent to a second computing device from the first computing device through a network. The first computing device includes a first cryptographically secure component and the second computing device includes a second cryptographically secure component. A new state digest is generated from the state digest and the result by the first cryptographically secure component. The generated new state digest is sent to the second computing device by the first computing device through the network. A request for an encryption key is sent to the second computing device through the network. The encryption key is generated from the new state digest by the second cryptographically secure component. The result is encrypted using the encryption key by the first cryptographically secure component. The encrypted result is sent to the second computing device by the first computing device through the network.

Implementations may include some or all of the following features. The encrypted result may be received at the second computing device. A state digest associated with the second cryptographically secure component may be updated to the new state digest. A decryption key may be generated by the second cryptographically secure component of the second computing device using the updated state digest. The encrypted result may be decrypted by the second cryptographically secure component using the generated decryption key. The result may be read by the second computing device. The request for a state digest may be received at the second computing device. The state digest may be retrieved from the cryptographically secure component of the second computing device. The state digest may be sent to the first computing device through the network. The current state digest may be retrieved from a platform configuration register of the second cryptographically secure component. The new state digest may be received by the second cryptographically secure component of the second computing device. The request for an encryption key digest may be received by the second cryptographically secure component of the second computing device. The encryption key may be generated by the second cryptographically secure component of the second computing device using the new state digest and a certificate associated with the second cryptographically secure component. The generated encryption key may be sent to the first computing device. The generated encryption key may be bound to the new state digest by the second cryptographically secure component. The second cryptographically secure component may include a trusted platform module.

This summary is provided to introduce a selection of concepts in a simplified form that is further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an example environment for providing read-undeniability and write-indisputability in a distributed application;

FIG. 2 is a block diagram of an implementation of an example trusted read and write platform;

FIG. 3 is an operational flow of an implementation of a method for providing write-indisputability;

FIG. 4 is an operational flow of an implementation of a method for providing read-undeniability; and

FIG. 5 is a block diagram of a computing system environment according to an implementation of the present system.

### DETAILED DESCRIPTION

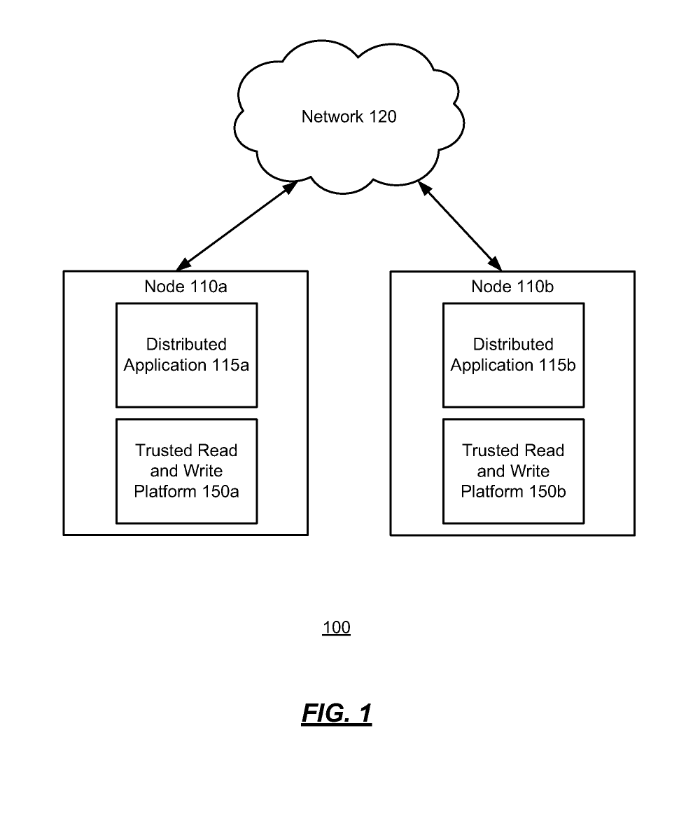

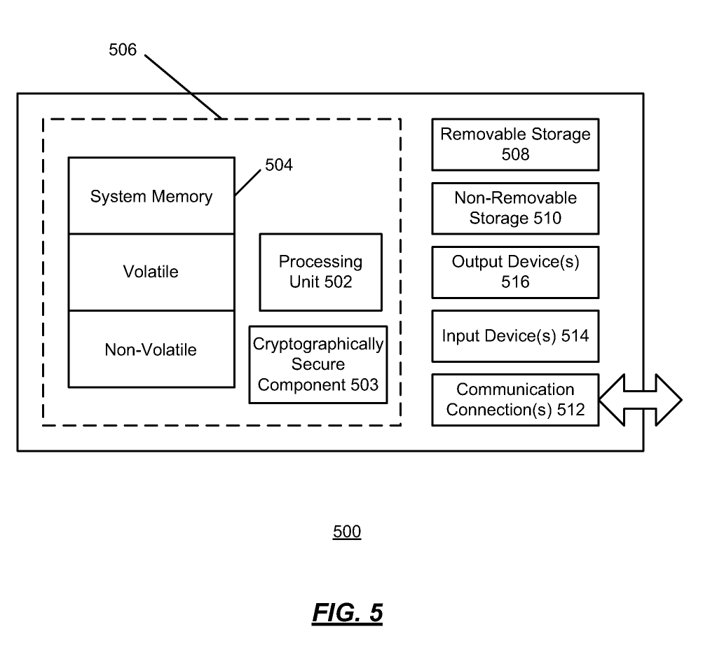

FIG. 1 is an illustration of an example environment 100 for providing read-undeniability and write-indisputability in a distributed application. As illustrated, the environment 100 includes a node 110a and a node 110b in communication with each other through a network 120. The network 120 may be a variety of network types including the public switched telephone network (PSTN), a cellular telephone network, and a packet switched network (e.g., the Internet). The node 110a and node 110b may be implemented using one or more general purpose computing devices such as the computing device 500 described with respect to FIG. 5, for example.

The nodes 110a and 110b may each execute a distributed application 115 (i.e., distributed applications 115a and 115b, respectively). The distributed applications 115a and 115b may be part of a decentralized distributed system. Examples of decentralized distributed systems may include online multiplayer video games and peer-to-peer file sharing systems. By executing distributed applications 115a and 115b, the nodes 110a and 110b may be considered nodes of the decentralized distributed system. While only two nodes 110 (i.e., nodes 110a and 110b) and two distributed applications 115 (i.e., distributed applications 115a and 115b) are shown, it is for illustrative purposes only; there is no limit to the number of nodes 110 and distributed applications 115 that may be supported. Moreover, it is contemplated that a single node 110 may execute multiple instances of the distributed application 115.

One feature of decentralized distributed systems is the lack of a centralized authority or application that coordinates the communications between the nodes 110. Thus, the node 110a may communicate (e.g., pass values, results, updates, etc.) directly with the node 110b through the network 120 and vice versa. Such decentralized communication is advantageous in an environment like the Internet where connections to the centralized authority may be unreliable. Moreover, such decentralized communication may provide for greater scalability since there is no centralized authority that coordinates all of the communications between the nodes 110.

One drawback associated with decentralized distributed systems is the possibility of read-denial attacks and write-equivocation attacks. As an example of a read-denial attack, the distributed application 115a of the node 110a may receive a communication from the node 110b, read the contents of the communication, and then claim that it had performed an operation or issued a particular command before the communication was received. As an example of a write-equivocation attack, the distributed application 115b of the node 110b may send a communication to the node 115a claiming to have written a particular value or generated a particular result when in fact it had generated a different value or generated a different result. Either attack may result in cheating or free riding, for example.

As a solution to above described attacks, each node 110 may include a trusted read and write platform 150 (i.e., trusted read and write platforms 150a and 150b, respectively). In some implementations, the trusted read and write platforms 150 may be used by the distributed applications 115 to provide what is referred to herein as read-undeniability and write-indisputability. Read-undeniability may ensure that a node 110 cannot deny that it read or observed contents or events contained in a message received from another node 110. For example, if the distributed application 115a of the node 110a receives a message from the node 110b it cannot later claim to have not observed the message to the node 110b or to any other node 110. In addition, read-undeniability may also prevent a node 110 from denying the order in which messages were received and observed. For example, the distributed application 115a of the node 110a cannot claim to have performed an operation before it received a message from the node 115b when in fact it performed the operation afterwards.

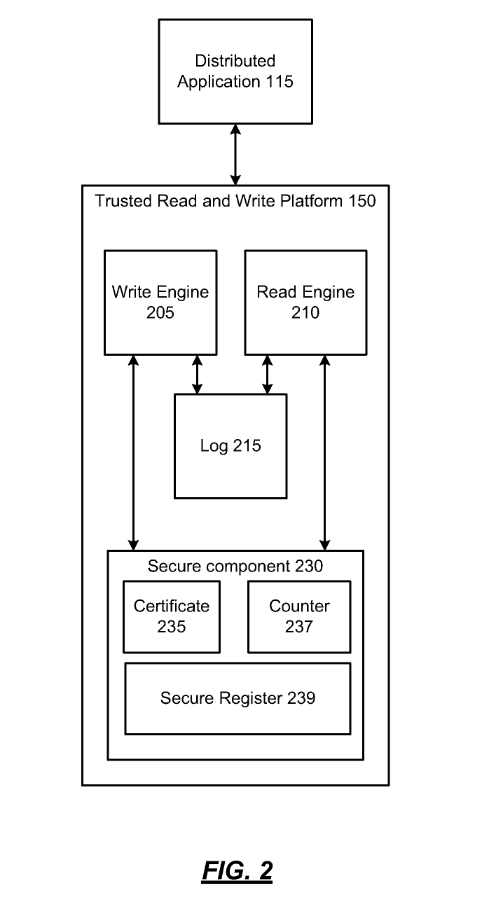

Write-indisputability may ensure that the nodes 110 cannot lie to other nodes 110 about the contents of an update or result. For example, if the distributed application 115a of the node 110a generates a result with a value X, it cannot tell the node 110b that it generated a result Y. Write-indisputability may further ensure that the nodes 110 cannot lie about the order with which updates were made at a node 110. For example, if the distributed application 115a of the node 110a makes a first update followed by a second update, it cannot tell the node 110b that the second update was made before the first update. Example methods and techniques used by the trusted read and write platforms 150 are described further below with respect to FIG. 2, for example.

FIG. 2 is a block diagram of an implementation of an example trusted read and write platform 150. As illustrated, in an implementation, the trusted read and write platform 150 may include a secure component 230. The secure component 230 may be a tramper-resistant component in that the contents of the component may not be changeable without using specific methods and/or functions provided by the secure component 230. The secure component 230 may be a hardware component, but it is contemplated that some or all of the aspects of the secure component 230 may be implemented using software, or some combination of software and hardware. In some implementations, the secure component 230 may be a trusted platform module. The trusted platform module is a standard secure co-processor that is found in many computing systems. Other systems and methods for providing a secure component 230 may also be used.

In some implementations, the secure component 230 may include a certificate 235. The certificate 235 may be a cryptographic certificate and may be unique to each secure component 230. Thus, a certificate 235 associated with the trusted read and write platform 150a may be different from a certificate 235 associated with the trusted read and write platform 150b. In some implementations, the certificate 235 is provided by a certifying authority. The certificate 235 may not be spoofed and therefore ensures that a message signed using a private key bound to the certificate 235 originates from the particular trusted read and write platform 150 associated with the certificate 235. The certificate 235 may also bind a particular public and private key pair to the secure component 230. The public and private key pair may be burnt into the hardware and the private key may never leave the secure component in clear text.

For example, the trusted read and write platform 150a of the node 110a may sign a generated result using a private key bound to the certificate 235, and the signed result may be transmitted to the node 110b. The private key may be part of a private/public key pair that is bound to the certificate 235 by an authority. To verify that the result is indeed from the node 110a, the trusted read and write platform 150b may retrieve the public key associated with the node 110a (i.e., the public key bound to the certificate 235 of the node 110a) and decrypt the signature associated with the generated result.

In some implementations, the secure component 230 may further be able to generate additional keys and/or certificates and sign results, internal state digests of the secure component 230, and other data. These keys may be related to or bound to the certificate 235, allowing the keys to be validated by an external entity (e.g., another trusted read and write platform 150) using a public key associated with or bound to the certificate 235 as described above, for example.

The secure component 230 may further include a secure register 239. The secure register 239 may be register that is adapted to store a state digest that describes a succession of states of the distributed application 115. In some implementations, the state digest may be a chained digest such as an SHA1 digest, for example. The state digest may be signed using the private key, or some other key generated from or bound to the certificate 235. The secure register 239 may be a platform configuration register of the trusted platform module, for example.

In some implementations, the secure register 239 may comprise a register that can be updated using a specialized cryptographically secure operation of the secure component 230. The operation is referred to herein as an extend operation. The extend operation when performed with a particular result H replaces the contents of the secure register 239 with the concatenation of the result with the contents of the secure register 239. For example, where the secure register 239 is a platform configuration register with a current state digest of PCR_{T}, the extend operation on the secure register 239 replaces PCR_{T} with PCR_{T+1} that is equal to SHA1(PCR_{T}∥H). The concatenation of a current generated or observed result by a distributed application 115 with the state digest of the distributed application 115 may be referred to as the current state of the distributed application 115.

The secure component 230 may further include a counter 237. The counter 237 may be a secure counter and may be implemented using a non-volatile monotonic hardware counter, for example. In some implementations, the counter 237 may used to keep a count of the current state of the distributed application 115. Thus, the counter 237 may be updated by the secure component 230 at each extend operation. While only one counter 237 is shown, there is no limit to the number of counters 237 that may supported by the secure component 230.

As described above, the secure register 239 may include a state digest that is a concatenation of previous states of the distributed application 115. Because the amount of memory available to the secure register 239 is finite, in some implementations, the state digest stored by secure register 239 may be a summary of the states of the distributed application 115, or may only include the most recent states of the distributed application 115. Accordingly, a complete log of the states of the distributed application 115 may be stored in a log 215 of the trusted read and write platform 150. The log 215 may be stored unencrypted in untrusted memory. If a malicious software application or adversarial node makes a change to a value of the log 215, the state digest stored in the secure register 239 may be used by the trusted read and write platform 150 to detect the change and potentially reverse the change.

As illustrated, the trusted read and write platform 150 may include a write engine 205 and a read engine 210. The write engine 205 may log write operations (e.g., updates, generated results, etc.) to the log 215 and the secure component 230. The read engine 210 may log read operations performed on incoming messages (e.g., messages indicating generated results or updates that have made) from other nodes 110 to the log 215 and the secure component 230. The particular read and write operations that are logged by the write engine 205 and the read engine 210 may be determined by the developers of the distributed application 115, for example. Logging read and write operations by the trusted read and write platform 150 may add overhead to the operation of the distributed application 115, thus only some subset of read and write operations may be logged. However, in distributed applications that are particularly vulnerable to attack, substantially all read and write operations may be logged.

In some implementations, the write engine 205 may be further adapted to generate transport sessions. A transport session may be initiated by the write engine 205 and may cause the secure component 230 to keep a log of all, or some subset of, the operations performed by the secure component 230 during the transport session. A transport session may last until instructed by the write engine 205. At the end of the transport session, the secure component 230 may generate a digest of the operations that were performed by the secure component 230. The digest may be signed by the secure component 230 using the private key bound to the certificate 235. This digest may be presented by the write engine 210 to instances of the distributed application 115 as proof that a particular instance of the distributed application 115 performed the operations listed in the digest. The proof may be used by the write engine 205 to provide write-indisputability.

In some implementations, the read engine 210 may be further adapted to bind keys to a selected value of a secure register 239. The keys may be generated from the certificate 235, and a value or result encrypted using such a key may only be decrypted by a secure component 230 when its secure register 239 has a value that is equal to the selected value. The bind operation may be used by the read engine 210 to provide read-undeniability by binding a generated result to a particular state digest, such that other nodes 110 may be assured that the state digest of the distributed application 115 is properly updated before a particular result may be read. Thus, the bind operation may be used by the read engine 210 to provide read-undeniability.

The write engine 205 may be used by the trusted read and write platform 150 to provide write-indisputability. After the distributed application 115 of a node 110 performs a write operation (e.g., generates a result) and updates its state digest, the trusted read and write platform 150 may use the write engine 205 to execute a write routine that ensures write-indisputability by the distributed application 115 to other instances of the distributed application 115 executing on other nodes 110. The write engine 205 of the distributed application 115 may execute the write routine before informing other distributed applications 115 of the generated result.

In some implementations, as part of executing the write routine, the write engine 205 may start a transport session at the secure component 230. As described above, the transport session may result in a record or log of the operations performed by the secure component 230 and may be signed using the certificate 235 of the secure component 230. The record may serve as proof that the trusted read and write platform 150 performed the indicated operations.

After starting the transport session, the write engine 205 may update the state digest stored in the secure register 239 to reflect the performance of the write operation. As described above, the state digest may be a concatenation of the previous states of the distributed application. In some implementations, the write engine 205 may update the secure register 239 using the extend operation, for example.

After updating the secure register 239 with the new state digest, the write engine 205 may increment the counter 237 to reflect the count of the new state digest. In addition, the write engine 205 may write the updated state digest and updated count to the log 215. By updating the log 215, the trusted read and write platform 150 may be able to recover the current state digest in the event of a reboot or failure of the node 110, for example.

After or before updating the log 215, the write engine 205 may close the transport session, resulting in the generation of a digest of the operations performed by the secure component 230. The digest may be signed using the private key bound to the certificate 235 of the secure component 230 and may serve as proof that the secure component 230 performed the operations indicated by the digest.

The write engine 205 may send the result that caused the state change to another distributed application 115. The write engine 205 may send the result along with the generated proof and the state digest stored in the secure register 239. In addition, the write engine may send the value of the counter 237. The receiving distributed application 115 may then retrieve the public key associated with or bound to the secure component 230 to authenticate the proof and determine if the current state indicated by the state digest matches the operations performed by the secure component 230 and the purported count value.

In this way, the trusted read and write platform 150 provides write-indisputability to the other distributed applications 115. Any distributed application 115 that receives the result and the generated proof can be assured that sending distributed application 115 in fact wrote the purposed result in the order indicated by the count value because of the signed proof that was generated by the secure component 230.

The trusted read and write platform 150 may use the read engine 210 to provide read-undeniability. After the distributed application 115 of the node 110 generates a result that it wants to send to another distributed application 115, the distributed application 115 may use the read engine 210 to invoke a read operation. In some implementations, the read engine 210, as part of the read operation, may first send a request for a state digest to a distributed application 115 of a node 110. For example, the distributed application 115a of the node 110a may send the distributed application 115b of the node 115b a request for the state digest from the secure component 230 if the node 115b.

After receiving the requested state digest, the read engine 210 may generate a new state digest from the received state digest. The new state digest may be generated by concatenating the result with the received state digest. The new state digest may comprise the state digest that the secure register 239 will have if the receiving distributed application 115 reads the generated result. Continuing the example described above, if the distributed application 115b receives the generated update and timely updates its secure register 239 to reflect the new state digest, the secure register 239 will have a state digest that is equal to the generated new state digest.

The read engine 210 may provide the updated state digest to the receiving distributed application 115, and may request that the receiving distributed application 115 bind a key to the updated state digest and provide the generated key. As described above, the secure component 230 may support a bind operation that generates a key based on a proposed state digest that may be used to encrypt a result. The secure component 230 may only decrypt a result that has been encrypted with the key when its secure register 239 has a state digest that is equal to the proposed state digest.

The read engine 210 may then encrypt the result using the generated key and provide the encrypted result to the receiving node. For example, the distributed application 115a may encrypt the result with the bound key that was received from the distributed application 115b. The distributed application 115b may then only decrypt the result after it has updated its secure register 239 to the new proposed state digest. This ensures read-undeniability in that that the node 115b cannot claim to have performed an operation before reading the update, or deny having read the update because it updates its state digest to the new proposed state digest in order to decrypt the update.

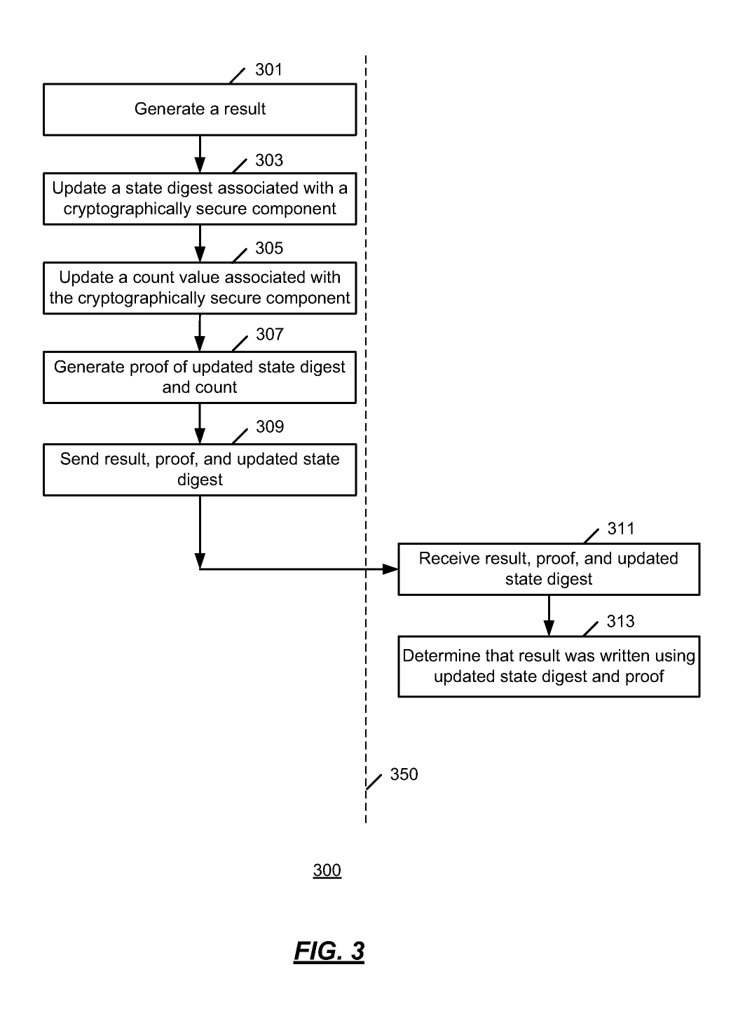

FIG. 3 is an operational flow of an implementation of a method 300 for providing write-indisputability. The method 300 may be implemented by a write engine 205 of a trusted read and write platform 150 of a node 110, for example. In FIG. 3, the operations to the left of the dotted line 350 may be performed by a first computing device (e.g., node 110a) and the operations to the right of the dotted line 350 may be performed by a second computing device (e.g., node 110b).

A result is generated at 301. The result may be generated by the distributed application 115a of the node 110a. The result may evidence an update or action taken by the distributed application 115a and may cause the performance of a write operation by the write engine 205 of the trusted read and write platform 150a. For example, the distributed application 115a may be an online videogame and the result may be the performance of an action by a character of the online videogame.

A state digest is updated at 303. The state digest may be updated by the write engine 205 of the trusted read and write platform 150a using an extend operation. The state digest may be updated to reflect the result that was generated at 301. In some implementations, the state digest may be a SHA1 digest including a concatenation of some or all of the previous states of the distributed application 115a. The state digest may be stored in a secure register 239 of the secure component 230. The secure register 239 may comprise a platform configuration register and the secure component 230 may comprise a trusted platform module. In some implementations, the updated state digest and count value may be added to the log 215.

A count value is updated at 305. The count value may be updated by the write engine 205. In some implementations, the count value may be stored in the counter 237 of the secure component 230. The count value may comprise a count associated with the current state of the distributed application 115a and may be updated by the secure component 230 for each state change or update.

A proof of the updated state digest and updated count value is generated at 307. The proof of the updated state digest may be generated by the secure component 230 and may include a record of the operations performed by the secure component 230 to update the state digest and to update the count value. In some implementations, the proof may be generated by the secure component 230 by the write engine 205 initiating a transport session after the result was generated at 301. The transport session may be closed by the write engine 205 after updating the count value. To allow the proof to be authenticated by other distributed applications 115, the proof may be signed by a private key bound to the certificate 235 of the secure component 230.

The result, proof, and updated state digest are sent at 309. The update, proof, and updated state digest may be sent by the distributed application 115a of the node 110a to the distributed application 115b of the node 110b through the network 120. In some implementations, the updated count value may also be sent. The result, proof, and updated state digest may be signed by the certificate 235 of the secure component 230.

The result, proof, and updated state digest are received at 311. The result, proof, and updated state digest may be received by the distributed application 115b of the node 110b. In an implementation, the public key bound to the certificate 235 of trusted applications 115b may be retrieved and used to decrypt and/or authenticate the result, proof, and updated state digest.

A determination is made whether the result was written using the updated state digest and proof, at 313. The determination may be made by the trusted read and write platform 150b of the node 110b, for example. In some implementations, the determination may be made by decrypting the proof and determining if the state indicated by the proof matches the updated state digest and that the proof indicates that the steps to write the result were performed by the secure component 230 of the trusted read and write platform 150a. By verifying that the secure component 230 updated its state digest according to the purported result, write-indisputability is provided because the distributed application 115a cannot later claim to the distributed application 115b that it did not write the purported result because the write is now reflected in its updated state digest.

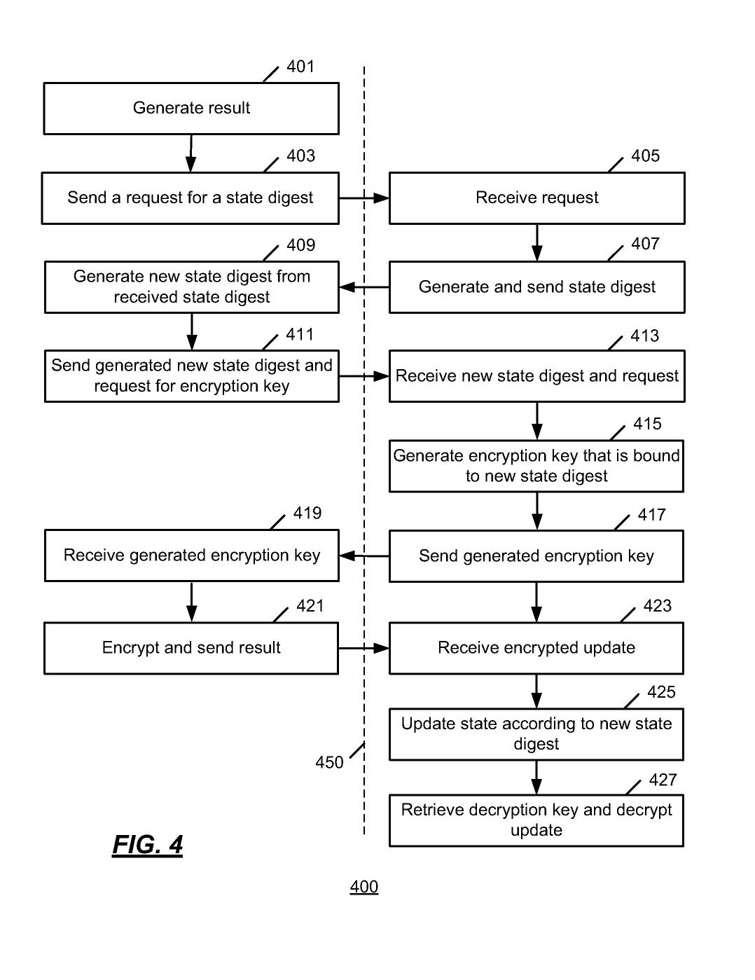

FIG. 4 is an operational flow of an implementation of a method 400 for providing read-undeniability. The method 400 may be implemented by the read engine 210 of the trusted read and write platform 150 of a node 110, for example. The operations to the left of the dotted line 450 may be performed by a first computing device (e.g., node 110a) and the operations to the right of the dotted line 450 may be performed by a second computing device (e.g., node 110b).

A result is generated at 401. The result may be generated by the distributed application 115a of the node 115a. The result may indicate an action taken by the distributed application 115a and may result in the performance of a read operation by the distributed application 115a.

A request is sent for a state digest at 403. The request may be sent by the read engine 210 of the distributed application 115a of the node 110a to the distributed application 115b of the node 110b. The request may be for the current state digest of the distributed application 115b. The read engine 210 may use the current state digest of the distributed application 115b to ensure that the distributed application 115b updates its state upon receiving the generated update, so that the distributed application 115b cannot lie about the order with which it reads the generated result, or deny having read the generated result.

The request is received at 405. The request may be received by the distributed application 115b. A state digest is generated and sent in response to the request at 407. The state digest may be generated by the distributed application 115b from the state digest stored in the secure register 239 of the secure component 230. In some implementations, the state digest is a SHA1 digest and may be signed using the certificate 235 of the secure component 230.

A new state digest is generated from the received state digest, at 409. The new state digest may be generated from the received state digest by the read engine 210 of the trusted read and write component 150a. In some implementations, the new state digest may be generated by concatenating the generated result with the received state digest. The new state digest represents the state digest that the distributed application 115b will store if it reads the generated result and accordingly updates its state digest.

The new state digest is sent along with a request for an encryption key at 411. The new state digest may be sent to the distributed application 115b by the read engine 210 along with a request for an encryption key. As described previously, the trusted read and write platform 150b may perform a bind operation that generates an encryption key that is bound to a particular value of the secure register 239 (i.e., state digest). Accordingly, the read engine 210 may request that the trusted read and write platform 150b generate an encryption key that is bound to the new state digest. Any results or other data encrypted using the encryption key may not be decrypted by the trusted read and write platform 150b until its state digest is updated to the bound state digest (i.e., the new state digest).

The new state digest and request are received at 413. The new state digest and request may be received by the distributed application 115a. An encryption key that is bound to the new state digest is generated at 415. The encryption key may be generated by the trusted read and write platform 150b by performing a bind operation using the new state digest.

The encryption key is sent at 417, e.g., to the distributed application 115a by the distributed application 115b. The encryption key is received at 419, e.g., by the distributed application 115a.

The result is encrypted using the encryption key and sent, at 421. The result may be encrypted by the read engine 210 using the received encryption key, and the encrypted result may be sent by the read engine 210 to the trusted read and write platform 150b. The encrypted result may be received at 423 by the trusted read and write component 150b of the node 110b.

At 425, the state digest is updated according to new state digest. The state digest of the trusted read and write component may be updated to the new state digest by performing an extend operation. The extend operation may replace the state digest stored in the secure register 239 with the new state digest. In some implementations, the trusted read and write platform 150b may further update the log 215 to reflect the new state digest.

At 427, the decryption key is retrieved and used to decrypt the result. The decryption key may be retrieved from the secure component 230 by the trusted read and write platform 150b. As described above, the decryption key may only be retrieved if the state digest stored in the secure register has been updated to the new state digest because the encryption key was bound to the new state digest. Thus, read-undeniability is assured because the trusted read and write platform 150b may only read the result after it has properly updated its state digest using the extend operation.

FIG. 5 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. The computing device 500 may further include a cryptographically secure component 503 such as a trusted platform module, for example. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by device 500 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communications connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
generating a result by a first computing device, wherein the first computing device includes a cryptographically secure component and the cryptographically secure component has an associated certificate;
updating a state digest associated with the cryptographically secure component by the first computing device to reflect the generation of the result;
generating a proof that the state digest was updated by the cryptographically secure component of the first computing device; and
sending the result, the updated state digest, and the generated proof to a second computing device through a network by the first computing device.

2. The method of claim 1, further comprising:
updating a count value associated with the cryptographically secure component; and
transmitting the updated count to the second computing device.

3. The method of claim 1, further comprising determining that the first computing device generated the result using the result, the updated state digest, and the generated proof.

4. The method of claim 1, wherein the cryptographically secure component comprises a trusted platform module.

5. The method of claim 1, wherein the certificate is bound to the cryptographically secure component.

6. The method of claim 1, wherein updating the state digest associated with the cryptographically secure component by the first computing device to reflect the generation of the result comprises:
retrieving the state digest associated with the cryptographically secure component from a secure register of the cryptographically secure component;
updating the state digest using the retrieved state digest and the result; and
storing the updated state digest in the secure register of the cryptographically secure component.

7. The method of claim 6, wherein the secure register comprises a platform configuration register.

8. The method of claim 1, wherein the state digest is an SHA1 digest.

9. A method comprising:
generating a result at a first computing device;
sending a request for a state digest to a second computing device from the first computing device through a network, wherein the first computing device includes a first cryptographically secure component and the second computing device includes a second cryptographically secure component;
generating a new state digest from the state digest and the result by the first cryptographically secure component;
sending the generated new state digest to the second computing device by the first computing device through the network;
sending a request for an encryption key to the second computing device through the network, wherein the encryption key is generated from the new state digest by the second cryptographically secure component;
encrypting the result using the encryption key by the first cryptographically secure component; and
sending the encrypted result to the second computing device by the first computing device through the network.

10. The method of claim 9, further comprising:
receiving the encrypted result at the second computing device;
updating a state digest associated with the second cryptographically secure component to the new state digest;
generating a decryption key by the second cryptographically secure component using the updated state digest;
decrypting the encrypted result by the second cryptographically secure component using the generated decryption key; and
reading the result by the second computing device.

11. The method of claim 9, further comprising:
receiving the request for a state digest at the second computing device;
retrieving the state digest from the second cryptographically secure; and
sending the state digest to the first computing device through the network.

12. The method of claim 11, wherein the state digest is retrieved from a platform configuration register of the second cryptographically secure component.

13. The method of claim 9, further comprising:
receiving the new state digest by the second cryptographically secure component;
receiving the request for an encryption key by the second cryptographically secure component;
generating the encryption key by the second cryptographically secure component using the new state digest and a certificate associated with the second cryptographically secure component; and
sending the generated encryption key to the first computing device.

14. The method of claim 13, further comprising binding the generated encryption key to the new state digest by the second cryptographically secure component.

15. The method of claim 9, wherein the second cryptographically secure component comprises a trusted platform module.

16. A system comprising:
at least one computing device;
a distributed application that generates a result; and
a cryptographically secure component that:
updates a state digest to reflect the generation of the result;
generates a proof that the state digest was updated; and
sends the result, the updated state digest, and the generated proof to a second computing device through a network.

17. The system of claim 16, wherein the cryptographically secure component comprises a trusted platform module.

18. The system of claim 16, wherein the cryptographically secure component further includes a certificate.

19. The system of claim 16, wherein the cryptographically secure component further includes a secure register and the cryptographically secure component updates a state digest to reflect the generation of the result by performing an extend operation on the secure register.

20. The system of claim 19, wherein the secure register comprises a platform configuration register.
